(19) United States
(12) Patent Application Publication
(10) Pub. No.: US 2025/0327699 A1
(43) Pub. Date: Oct. 23, 2025

(54) TUBE SHAPE FOR CORIOLIS MASS FLOW METER

(71) Applicant: Dionex Softron GmbH, Germering (DE)

(72) Inventor: Michael Haeckel, Germering (DE)

(73) Assignee: Dionex Softron GmbH, Germering (DE)

(21) Appl. No.: 19/185,174

(22) Filed: Apr. 21, 2025

(30) Foreign Application Priority Data
Apr. 22, 2024 (DE) 10 2024 111 155.0

(51) Int. Cl. G01F 1/84

(52) U.S. Cl. CPC G01F 1/8486; G01F 1/8422

(57) ABSTRACT

The present disclosure relates to a measuring tube for a Coriolis flow meter, comprising a looped tube section, and two connecting tube sections, wherein a first end of each of the two connecting tube sections is respectively fluidly connected to a different end of the looped tube section. Further, each of the connecting tube sections comprises a first portion and a second portion, wherein the looped tube section defines a first plane, wherein the second portion of each connecting tube section extends out of the first plane in a first direction, and wherein the first portion of each connecting tube section extends out of the first plane in a direction opposite to the first direction. Additionally the present disclosure relates to a Coriolis flow meter comprising a respective measuring tube.

### CROSS-REFERENCE TO RELATED APPLICATION

This application claims priority from German patent application no. DE 10 2024 111 155.0, filed Apr. 22, 2024. The entire disclosure of DE 10 2024 111 155.0 is incorporated herein by reference.

### FIELD

The present disclosure generally relates to Coriolis mass flow meters and particularly to a tube for Coriolis mass flow meters.

### BACKGROUND

At present, the flow rate of analytical liquid chromatography (LC) and high-performance liquid chromatography (HPLC) systems and thus also the composition of the mobile phase may be controlled solely by the operation of the pump, e.g., by the piston movement. That is, the piston movement may be measured during each pump stroke and the resulting flow rate may be inferred considering the displaced volume in the pumping chamber based on the piston movement. However, this may typically result in very high demands on the tightness of all involved components. Otherwise, the piston movement may not provide a good measure as fluid may leak out and therefore not contribute to the flow rate. This may however result in more complex and elaborate designs of the pumps, as well as higher demands on materials involved.

Furthermore, compressibility and thermal expansion of the fluid may require compensation, as they can influence the flow rate inferred from the displaced volume. Thermal expansion may not only occur due to changes of the ambient temperature but also due to adiabatic heating during the pumping process. Therefore, inferring the flow rate from the piston displacement may require careful calibration with respect to said fluid characteristics and thus, good knowledge of said fluid characteristics may be required, which can for example be particularly difficult when solvent gradients are used, i.e., when the composition of the mobile phase varies over time.

Thus, it would generally be desirable to measure the provided flow rate, which would allow to correct for deficiencies of the pump, e.g., by means of respective control mechanisms, and accuracy requirements for the pump could be relaxed. However, measuring the flow rate requires provision of an accurate and cost-effective flow sensor for a respective flow range, e.g., a flow range of 50 μl/min to 5 ml/min.

There are mainly three different types of sensors that could be used for flow measurements in HPLC applications: thermal mass flow meters, ultrasonic flow meters and Coriolis mass flow meters. However, currently no sensor appears to be widely used that can measure with sufficient accuracy in the desired flow and pressure range, e.g., a flow range of 50 μl/min to 5 ml/min and a pressure range of 5-150 MPa.

Currently, mainly thermal mass flow meters are used for low-flow HPLC. Each of the different sensor types offers certain advantages and disadvantages. For example, thermal mass flow meters and ultrasonic flow meters may depend on the characteristics of the fluid and thus also require careful calibration. One particular advantage of using a Coriolis mass flow meter is that it provides a linear response to the mass flow through the sensor and that it is independent of the fluid characteristics. Furthermore, it can advantageously also measure the density of the fluid independent of the mass flow measurement. In other words, a Coriolis mass flow meter is linear, solvent independent, and can also measure density, which in turn also allows to determine the volume flow rate.

Unlike current analytical HPLC pumps which control the volume flow, the retention times can be kept stable independent of the ambient temperature if the mass flow rate is kept constant. In other words, it may be advantageous to measure the mass flow rate instead of the volume flow since this may allow for stable retention times independent of the ambient temperature, i.e., without the need to further take into account and/or control the ambient temperature of the system. Therefore, it may be desirable to have a measurement of the mass flow rate which is inherently provided by a Coriolis mass flow meter.

In a Coriolis mass flow meter, a flow of fluid may generally be forced to move in a non-rectilinear manner through at least one tube, which may comprise a curved or straight tube geometry. The at least one tube is forced to oscillate and due to its rotational flow, the liquid causes a torsion on the at least one tube by means of the Coriolis force. The torsion may be measured by measuring the displacement of the tube in at least two locations, wherein one location may be upstream and the other location may be downstream of the centre of the tube in flow direction. Preferably the two locations are arranged symmetrically around the centre of the tube in flow direction. Thus, the torsion may result in a phase shift between the overall oscillation measured at the two locations. Based on the measured torsion, e.g., the measured phase shift, the mass flow rate can be determined. Furthermore, a change in oscillation frequency may allow to measure the density of the fluid, as the natural frequency of the tube depends on the mass of the tube and the comprised fluid. Thus, it allows for a measurement of the fluid mass and based on the known volume of the tube, the density of the fluid.

In known Coriolis flow meters, the simplest possible shape is often used for the tube. However, this generally does not provide the best possible measurement signal. The detector that measures the movement due to the Coriolis effect also detects the excitation of the tube, i.e., its forced oscillation. The movement due to the excitation can be many orders of magnitude greater than the actual measurement signal due to the Coriolis effect. For many applications at high flow rates, the accuracy is nevertheless sufficient. However, especially if there is a desire to measure low flow rates (<1 g/min) at high pressure (up to 1500 bar) accurately, an improved (preferably optimal) shape may be needed that offers a greater (preferably the largest possible) deflection due to the Coriolis effect at points where the excitation causes only a weak oscillation.

Furthermore, if the flow rate changes rapidly, inertia will cause a recoil on the tube. Although a double piston pump can basically deliver a constant flow rate, at the time when the discharge valve opens or closes, a short very strong flow rate variation occurs. For a short time, either double the flow rate may be delivered or no flow at all. Such an impulse can cause the tube to vibrate, which can disturb the measurement signal. To avoid measurement errors due to rapid flow rate changes, the tube is usually bent into a symmetrical flat shape. This however limits the possibilities of obtaining the strongest possible measurement signal.

A symmetric, three-dimensional tube shape is in principle known. For example, U.S. Pat. No. 4,716,771 A discloses such a tube shape. However, for the disclosed tube shape the excitation is disadvantageously strongly present in the detector signal.

In “Modelling a Coriolis Mass Flow Meter for Shape Optimization”, W. B. J. Hakvoort et al., The 1^{st} Joint International Conference on Multibody System Dynamics, May 25-27, 2010, Lappeenranta, Finland, a Coriolis mass flow meter is modelled for shape optimization. The respective simulations show that a shape for which inlet and outlet are located on the inside and the tube is routed once around the outside is well suited for a Coriolis mass flow meter with linear excitation and detection of rotational movement and produces a significantly larger measurement signal. Even better results may be achieved by further prolonging the connections. Such a shape is however impossible in a flat form as it would lead to a crossing of the tube.

An alternative solution for evading the problem is to excite a torsional movement and detect a linear movement as for example disclosed in EP 1 719 982 B1. In this case, it is possible to position the detectors at points where only a very small movement occurs due to the excitation. However, this approach has the disadvantage that the excitation of a torsional vibration is very complex, which may render a respective flow meter expensive (many different components are required) and it typically is very sensitive to external mechanical vibrations.

### SUMMARY

In light of the above, it is an object to overcome or at least alleviate the shortcomings and disadvantages of the prior art. More particularly, it is an object of the present disclosure to provide an improved measuring tube of a Coriolis flow meter.

These objects are met by the present disclosure.

In one aspect, the present disclosure relates to a measuring tube for a Coriolis flow meter, comprising a looped tube section, and two connecting tube sections, wherein a first end of each of the two connecting tube sections is respectively fluidly connected to a different end of the looped tube section. Further, each of the connecting tube sections comprises a first portion and a second portion, wherein the looped tube section defines a first plane, wherein the second portion of each connecting tube section extends out of the first plane in a first direction, and wherein the first portion of each connecting tube section extends out of the first plane in a direction opposite to the first direction. In other words, the measuring tube may generally comprise a looped tube section defining a first plane and two connecting tube sections, which are fluidly connected to respective ends of the looped tube section and which extend out of the first plane partially in the first direction and partially in a direction opposite to the first direction. This may advantageously allow to keep the centre of mass of the connecting tube section at least close to the first plane while at the same time allowing for the second portion of each connecting tube section to extend out of the first plane in the first direction, e.g., to allow for fluidly connecting to other tubes.

The measuring tube may comprise two detection positions arranged symmetrically around a centre of the measuring tube in a flow direction. These detection positions may advantageously be configured such that undesired oscillations (e.g., owing to rapid flow rate changes) may be oriented in a different direction than oscillations owing to the Coriolis force.

The measuring tube may be symmetric with respect to a symmetry plane perpendicular to the first plane. In other words, the measuring tube may be mirror symmetric with respect to a symmetry plane perpendicular to the first plane.

Preferably, the measuring tube may be manufactured from a single integral piece of tubing. In some embodiments, the measuring tube may be made of metal, which may preferably be stainless steel or a nickel-cobalt base alloy like MP35N.

The measuring tube may comprise a tube length in the range of 50 mm to 500 mm, preferably 100 mm to 200 mm, more preferably 120 mm to 180 mm. Additionally or alternatively, the measuring tube may comprise an outer tube diameter in the range of 0.2 to 1 mm, preferably 0.2 to 0.7 mm, more preferably 0.25 mm to 0.5 mm. Similarly, the measuring tube may comprise an inner tube diameter in the range of 0.05 to 0.95 mm, preferably 0.1 to 0.5 mm, more preferably 0.15 mm to 0.25 mm.

The measuring tube may comprise an eigenfrequency in the range of 50-500 Hz, preferably 80-200 Hz, more preferably 100-150 Hz. Additionally or alternatively, the measuring tube may be configured for internal pressures of at least up to 500 bar, preferably at least up to 1000 bar, more preferably of at least up to 1500 bar. In some embodiments, the measuring tube may at least be configured for mass flow rates in the range of 0-2 g/min, preferably 0-5 g/min, more preferably 0-10 g/min.

The looped tube section may resemble a rectangular shape with rounded corners. Alternatively, the looped tube section may for example resemble a circular or elliptic shape. Additionally or alternatively, the looped tube section may be symmetric with respect to the symmetry plane perpendicular to the first plane.

The looped tube section may comprise a loop width in the range of 10 mm to 40 mm, preferably 15 mm to 35 mm, more preferably 20 mm to 30 mm. Additionally or alternatively, the looped tube section may comprise a loop depth in the range of 10 mm to 40 mm, preferably 15 mm to 35 mm, more preferably 20 mm to 30 mm. The looped tube section may comprise a loop length in the range of 50 mm to 150 mm, preferably 70 mm to 130 mm, more preferably 80 mm to 120 mm. In some embodiments, the ends of the looped tube section are less than 20 mm, preferably less than 15 mm, more preferably less than 10 mm apart.

The two connecting tube sections may be mirror-symmetrical to each other. In some embodiments, the two connecting tube sections may be identically shaped.

For each connecting tube section, the second portion may be further distanced from the looped tube section than the first portion. Additionally or alternatively, each connecting tube section may comprise a first end and wherein the first end of the two connecting tube sections may respectively be fluidly connected to a different end of the looped tube section.

Each connecting tube section may comprise a section width in the range of 5 mm to 35 mm, preferably 10 mm to 30 mm, more preferably 15 mm to 25 mm. Additionally or alternatively, each connecting tube section may comprise a section height in the range of 1 mm to 20 mm, preferably 3 mm to 15 mm, more preferably 5 mm to 10 mm. Similarly, each connecting tube section may comprise a section length in the range of 10 mm to 50 mm, preferably 15 mm to 40 mm, more preferably 20 mm to 30 mm.

The two connecting tube sections may run parallel to each other.

The first portions of the two connecting tube sections may define a second plane which is at a non-zero angle with respect to the first plane. The angle may be within the range of 1° to 30°, preferably 2° to 15°, more preferably 3° to 6°.

The first portions of the two connecting tube sections may be configured to compensate for an asymmetry of the measuring tube introduced by the second portion.

The arrangement and/or dimension of the first portion of each connecting tube section may be designed such that a lateral oscillation mode of the measuring tube that can be excited due to rapid flow changes does substantially not comprise a component perpendicular to the first plane in a vicinity of the detection positions. It will be understood that while being generally designed such that the lateral oscillation mode of the measuring tube that can be excited due to rapid flow changes does not comprise a component perpendicular to the first plane in a vicinity of the detection positions, the actual measuring tube may nonetheless not be perfect due to manufacturing tolerances. Such unavoidable deviation due to manufacturing tolerances are accounted for by the term “substantially”. This is even more true since movements of the measurement tube may be measured with an accuracy of 0.01 nm (corresponding to 1/10 of the atomic distance in a metal the tube is made of), such that also very small disturbances will be detectable.

The arrangement and/or dimension of the first portion of each connecting tube section may be designed such that a lateral oscillation mode of the measuring tube that can be excited due to rapid flow changes does substantially not comprise a component perpendicular to the first plane. Like above it will be understood that while being generally designed such that the lateral oscillation mode of the measuring tube that can be excited due to rapid flow changes does not comprise a component perpendicular to the first plane, the actual measuring tube may nonetheless not be perfect due to manufacturing tolerances. Such unavoidable deviation due to manufacturing tolerances are accounted for by the term “substantially”.

The arrangement and/or dimensions of the first portion may be determined experimentally or via calculations based on the finite element method.

The second portion of each connecting tube section may be oriented perpendicular to the first plane.

The second portion of each connecting tube section may be configured to be fixedly mounted to a holder and/or excitation device. Additionally or alternatively, each connecting tube section may comprise a second end, wherein each second end may be configured to be fixedly mounted to the holder and/or excitation device. Further, the second ends of the two connecting tube sections are distanced from each other by a second end distance in the range of 1 to 15 mm, preferably 2 to 10 mm, more preferably 3 to 7 mm.

For each connecting tube section, the first portion may be located between the respective second portion and the looped tube section.

In another aspect, the present disclosure relates to a Coriolis flow meter comprising a measuring tube as described herein, an excitation device configured to excite an oscillation of the measuring tube, and two position detectors configured to detect a position of the measuring tube with respect to one dimension.

The Coriolis flow meter may comprise a holder and wherein the measuring tube is fixedly mounted to the holder. Further, each connecting tube section of the measuring tube may comprise a second end, wherein each second end may be fixedly mounted to the holder such that there is a rigid connection between the two second ends. The excitation device may be configured to periodically oscillate the two second ends with an amplitude in the range of 0.5 μm to 5 μm, preferably in the range of 1 μm to 3 μm. Additionally or alternatively, the excitation device may be configured to periodically oscillate the two second ends with a frequency in the range of 50 to 500 Hz, preferably in the range of 80 to 200 Hz, more preferably 100 to 150 Hz. In some embodiments, the holder may be comprised by the excitation device.

The Coriolis flow meter may be configured such that at the detection positions a movement owing to an excitation provided by the excitation device is smaller than 100 μm preferably smaller than 50 μm. In particular, an amplitude of the movement owing to an excitation may be smaller than half of the outer tube diameter at the detection positions. This may allow for detecting a position of the tube at the detection positions with a light barrier. For example, a 1 μm excitation amplitude may lead to a deflection of the tube by 500 μm due to the resonance magnification. At the detection positions, however, the measurement tube may only be deflected by 50 μm. Additionally or alternatively, the Coriolis flow meter may be configured such that at the detection positions a movement owing to the Coriolis force may be at least 75% of the maximum deflection caused by the Coriolis force.

The Coriolis flow meter may be configured such that a movement owing to an undesired excitation originating from a rapid flow change results in a lateral oscillation mode that is perpendicular to the deflection owing to the Coriolis force at least in a vicinity of the detection points.

The Coriolis flow meter may be configured such that a movement owing to an undesired excitation originating from a rapid flow change results in a lateral oscillation mode that is perpendicular to a direction in which the two position detectors are configured to detect the position of the measuring tube.

The excitation device may comprise a piezoelectric actuator. That is, a piezoelectric actuator may be used to excite oscillations of the measuring tube.

The Coriolis flow meter may be configured such that the Coriolis force induces an oscillation of the measuring tube that is 90° phase-shifted with respect to an excitation oscillation induced via the excitation device. This may advantageously allow to reduce contributions of the excitation oscillation to a measurement of the oscillations induced by the Coriolis force.

Each position detector may be located at one of the two detection positions of the measuring tube, respectively. Additionally or alternatively, the two position detectors may each comprise at least one optical sensor.

The two position detectors may be configured to only detect the position of the measuring tube in a direction perpendicular to the first plane defined by the looped tube section of the measuring tube.

The Coriolis flow meter may be configured to measure mass flow rates at least in the range of 0 to 2 g/min, preferably at least in the range of 0 to 5 g/min, more preferably at least in the range of 0 to 10 g/min. Additionally or alternatively, the Coriolis flow meter is configured to measure mass flow rates at fluid pressures at least in the range of 5 to 50 MPa, preferably at least in the range of 5 to 100 MPa, more preferably at least in the range of 0 to 150 MPa. Similarly, the Coriolis flow meter may be configured to measure mass flow rates with an accuracy of 100 μg/min, preferably 30 μg/min, more preferably 10 μg/min. Thus, the Coriolis flow meter may advantageously be particularly suited for (HP) LC applications.

In a further aspect, the present disclosure relates to a use of the above-described Coriolis flow meter to regulate flow in a chromatography system, preferably in a liquid chromatography system and particularly in a high-performance liquid chromatography system.

Generally, it will thus be understood that embodiments of the present disclosure relate to an improved measuring tube for a Coriolis flow meter. The tube (and particularly a shape thereof) comprises locations wherein the movement owing to the excitation oscillation is small (ideally minimized) while the deflection due to the Coriolis force is as large (ideally maximized). At the same time, the shape may be configured to lower (ideally minimize) the impact of flow rate changes on the measuring tube. Furthermore, the measuring tube may be configured to be excited by a piezoelectric actuator.

Below, reference will be made to measuring tube embodiments. These embodiments are abbreviated by the letter “T” followed by a number. Whenever reference is herein made to “tube embodiments”, these embodiments are meant.

T1. Measuring tube for a Coriolis flow meter, comprising
a looped tube section,
and two connecting tube sections,
wherein a first end of each of the two connecting tube sections is respectively fluidly connected to a different end of the looped tube section,
wherein each of the connecting tube sections comprises a first portion and a second portion,
wherein the looped tube section defines a first plane,
wherein the second portion of each connecting tube section extends out of the first plane in a first direction, and
wherein the first portion of each connecting tube section extends out of the first plane in a direction opposite to the first direction.

T2. The measuring tube according to the preceding tube embodiment, wherein the measuring tube comprises two detection positions arranged symmetrically around a centre of the measuring tube in a flow direction.

T3. The measuring tube according any of the preceding tube embodiments, wherein the measuring tube is symmetric with respect to a symmetry plane perpendicular to the first plane.

T4. The measuring tube according to any of the preceding tube embodiments, wherein the measuring tube is manufactured from a single integral piece of tubing.

T5. The measuring tube according to any of the preceding tube embodiments, wherein the measuring tube is made of metal.

T6. The measuring tube according to the preceding tube embodiment, wherein the metal is stainless steel or a nickel-cobalt base alloy like MP35N.

T7. The measuring tube according to the any of the preceding tube embodiments, wherein the measuring tube comprises a tube length in the range of 50 mm to 500 mm, preferably 100 mm to 200 mm, more preferably 120 mm to 180 mm.

T8. The measuring tube according to any of the preceding tube embodiments, wherein the measuring tube comprises an outer tube diameter in the range of 0.2 to 1 mm, preferably 0.2 to 0.7 mm, more preferably 0.25 mm to 0.5 mm.

T9. The measuring tube according to any of the preceding tube embodiments, wherein the measuring tube comprises an inner tube diameter in the range of 0.05 to 0.95 mm, preferably 0.1 to 0.5 mm, more preferably 0.15 mm to 0.25 mm.

T10. The measuring tube according to any of the preceding tube embodiments, wherein the measuring tube comprises an eigenfrequency in the range of 50-500 Hz, preferably 80-200 Hz, more preferably 100-150 Hz.

T11. The measuring tube according to any of the preceding tube embodiments, wherein the measuring tube is configured for internal pressures of at least up to 500 bar, preferably at least up to 1000 bar, more preferably of at least up to 1500 bar.

T12. The measuring tube according to any of the preceding tube embodiments, wherein the measuring tube is at least configured for mass flow rates in the range of 0-2 g/min, preferably 0-5 g/min, more preferably 0-10 g/min.

T13. The measuring tube according to any of the preceding tube embodiments, wherein the looped tube section resembles a rectangular shape with rounded corners.

T14. The measuring tube according to the penultimate tube embodiment, wherein the looped tube section resembles a circular or elliptic shape.

T15. The measuring tube according to any of the preceding tube embodiments, wherein the looped tube section is symmetric with respect to the symmetry plane perpendicular to the first plane.

T16. The measuring tube according to any of the preceding tube embodiments, wherein the looped tube section comprises a loop width in the range of 10 mm to 40 mm, preferably 15 mm to 35 mm, more preferably 20 mm to 30 mm.

T17. The measuring tube according to any of the preceding tube embodiments, wherein the looped tube section comprises a loop depth in the range of 10 mm to 40 mm, preferably 15 mm to 35 mm, more preferably 20 mm to 30 mm.

T18. The measuring tube according to any of the preceding tube embodiments, wherein the looped tube section comprises a loop length in the range of 50 mm to 150 mm, preferably 70 mm to 130 mm, more preferably 80 mm to 120 mm.

T19. The measuring tube according to any of the preceding tube embodiments, wherein the ends of the looped tube section are less than 20 mm, preferably less than 15 mm, more preferably less than 10 mm apart.

T20. The measuring tube according to any of the preceding tube embodiments, wherein the two connecting tube sections are mirror-symmetrical to each other.

T21. The measuring tube according to any of the preceding tube embodiments, wherein the two connecting tube sections are identically shaped.

T22. The measuring tube according to any of the preceding tube embodiments, wherein for each connecting tube section the second portion is further distanced from the looped tube section than the first portion.

T23. The measuring tube according to any of the preceding tube embodiments, wherein each connecting tube section comprises a first end and wherein the first end of the two connecting tube sections is respectively fluidly connected to a different end of the looped tube section.

T24. The measuring tube according to any of the preceding tube embodiments, wherein each connecting tube section comprises a section width in the range of 5 mm to 35 mm, preferably 10 mm to 30 mm, more preferably 15 mm to 25 mm.

T25. The measuring tube according to any of the preceding tube embodiments, wherein each connecting tube section comprises a section height in the range of 1 mm to 20 mm, preferably 3 mm to 15 mm, more preferably 5 mm to 10 mm

T26. The measuring tube according to any of the preceding tube embodiments, wherein each connecting tube section comprises a section length in the range of 10 mm to 50 mm, preferably 15 mm to 40 mm, more preferably 20 mm to 30 mm.

T27. The measuring tube according to any of the preceding tube embodiments, wherein the two connecting tube sections run parallel to each other.

T28. The measuring tube according to any of the preceding tube embodiments, wherein the first portions of the two connecting tube sections define a second plane which is at a non-zero angle with respect to the first plane.

T29. The measuring tube according to the preceding tube embodiment, wherein the angle is within the range of 1° to 30°, preferably 2° to 15°, more preferably 3° to 6°.

T30. The measuring tube according to any of the preceding tube embodiments, wherein the first portions of the two connecting tube sections are configured to compensate for an asymmetry of the measuring tube introduced by the second portion.

T31. The measuring tube according to any of the preceding tube embodiments and with features of T2, wherein the arrangement and/or dimension of the first portion of each connecting tube section is designed such that a lateral oscillation mode of the measuring tube that can be excited due to rapid flow changes does substantially not comprise a component perpendicular to the first plane in a vicinity of the detection positions.

T32. The measuring tube according to any of the preceding tube embodiments, wherein the arrangement and/or dimension of the first portion of each connecting tube section is designed such that a lateral oscillation mode of the measuring tube that can be excited due to rapid flow changes does substantially not comprise a component perpendicular to the first plane.

T33. The measuring tube according to any of the preceding tube embodiments, wherein the arrangement and/or dimensions of the first portion are determined experimentally or via calculations based on the finite element method.

T34. The measuring tube according to any of the preceding tube embodiments, wherein the second portion of each connecting tube section is oriented perpendicular to the first plane.

T35. The measuring tube according to any of the preceding tube embodiments, wherein the second portion of each connecting tube section is configured to be fixedly mounted to a holder and/or excitation device.

T36. The measuring tube according to any of the preceding tube embodiments, wherein each connecting tube section comprises a second end, wherein each second end is configured to be fixedly mounted to the holder and/or excitation device.

T37. The measuring tube according to the preceding tube embodiment, wherein the second ends of the two connecting tube sections are distanced from each other by a second end distance in the range of 1 to 15 mm, preferably 2 to 10 mm, more preferably 3 to 7 mm.

T38. The measuring tube according to any of the preceding tube embodiments, wherein for each connecting tube section, the first portion is located between the respective second portion and the looped tube section.

Below, reference will be made to Coriolis flow meter embodiments. These embodiments are abbreviated by the letter “F” followed by a number. Whenever reference is herein made to “flow meter embodiments”, these embodiments are meant.

F1. Coriolis flow meter comprising
a measuring tube according to any of the preceding tube embodiments;
an excitation device configured to excite an oscillation of the measuring tube; and
two position detectors configured to detect a position of the measuring tube with

respect to one dimension.

F2. Coriolis flow meter according to the preceding flow meter embodiment, wherein the Coriolis flow meter comprises a holder and wherein the measuring tube is fixedly mounted to the holder.

F3. Coriolis flow meter according to the preceding flow meter embodiment, wherein the measuring tube comprises the features of T36, wherein each second end is fixedly mounted to the holder such that there is a rigid connection between the two second ends.

F4. Coriolis flow meter according to the preceding flow meter embodiment, wherein the excitation device is configured to periodically oscillate the two second ends with an amplitude in the range of 0.5 μm to 5 μm, preferably in the range of 1 μm to 3 μm.

F5. Coriolis flow meter according to any of the 2 preceding flow meter embodiments, wherein the excitation device is configured to periodically oscillate the two second ends with a frequency in the range of 50 to 500 Hz, preferably in the range of 80 to 200 Hz, more preferably 100 to 150 Hz.

F6. Coriolis flow meter according to any of the 4 preceding flow meter embodiments, wherein the holder is comprised by the excitation device.

F7. Coriolis flow meter according to any of the preceding flow meter embodiments, wherein the measuring tube comprises the features of T2 and wherein the Coriolis flow meter is configured such that at the detection positions a movement owing to an excitation provided by the excitation device is smaller than 100 μm preferably smaller than 50 μm.

F8. Coriolis flow meter according to any of the preceding flow meter embodiments, wherein the measuring tube comprises the features of T2 and wherein the Coriolis flow meter is configured such that at the detection positions a movement owing to the Coriolis force is at least 75% of the maximum deflection caused by the Coriolis force.

F9. Coriolis flow meter according to any of the preceding flow meter embodiments, wherein the measuring tube comprises the features of T2 and wherein the Coriolis flow meter is configured such that a movement owing to an undesired excitation originating from a rapid flow change results in a lateral oscillation mode that is perpendicular to the deflection owing to the Coriolis force at least in a vicinity of the detection points.

F10. Coriolis flow meter according to any of the preceding flow meter embodiments, wherein the Coriolis flow meter is configured such that a movement owing to an undesired excitation originating from a rapid flow change results in a lateral oscillation mode that is perpendicular to a direction in which the two position detectors are configured to detect the position of the measuring tube.

F11. Coriolis flow meter according to any of the preceding flow meter embodiments, wherein the excitation device comprises a piezoelectric actuator.

F12. Coriolis flow meter according to any of the preceding flow meter embodiments, wherein the Coriolis flow meter is configured such that the Coriolis force induces an oscillation of the measuring tube that is 90° phase-shifted with respect to an excitation oscillation induced via the excitation device.

F13. Coriolis flow meter according to any of the preceding flow meter embodiments, wherein the measuring tube comprises the features of T2, wherein each position detector is located at one of the two detection positions, respectively.

F14. Coriolis flow meter according to any of the preceding flow meter embodiments, wherein the two position detectors each comprise at least one optical sensor.

F15. Coriolis flow meter according to any of the preceding flow meter embodiments, wherein the two position detectors are configured to only detect the position of the measuring tube in a direction perpendicular to the first plane defined by the looped tube section of the measuring tube.

F16. Coriolis flow meter according to any of the preceding flow meter embodiments, wherein the Coriolis flow meter is configured to measure mass flow rates at least in the range of 0 to 2 g/min, preferably at least in the range of 0 to 5 g/min, more preferably at least in the range of 0 to 10 g/min.

F17. Coriolis flow meter according to any of the preceding flow meter embodiments, wherein the Coriolis flow meter is configured to measure mass flow rates at fluid pressures at least in the range of 5 to 50 MPa, preferably at least in the range of 5 to 100 MPa, more preferably at least in the range of 0 to 150 MPa.

F18. Coriolis flow meter according to any of the preceding flow meter embodiments, wherein the Coriolis flow meter is configured to measure mass flow rates with an accuracy of 100 μg/min, preferably 30 μg/min, more preferably 10 μg/min.

Below, reference will be made to use embodiments. These embodiments are abbreviated by the letter “U” followed by a number. Whenever reference is herein made to “use embodiments”, these embodiments are meant.

U1. Use of the Coriolis flow meter according to any of the preceding flow meter embodiments to regulate flow in a chromatography system.

U2. Use of the Coriolis flow meter according to any of the preceding flow meter embodiments to regulate flow in a liquid chromatography system.

U3. Use of the Coriolis flow meter according to any of the preceding flow meter embodiments to regulate flow in a high-performance liquid chromatography system.

The present disclosure is presented with a particular focus on the measurement of a mass flow rate in liquid chromatography (LC) and more particularly high-performance liquid chromatography (HPLC). However, it will be understood that the present technology may also be used in the context of other applications with similar conditions, e.g., high pressures and volume flow rates in the μ/min to ml/min range, where precise measurements of the mass flow rate are advantageous.

### BRIEF DESCRIPTION OF THE DRAWINGS

Embodiments according to the present disclosure will now be described with reference to the accompanying drawings. These embodiments should only exemplify, but not limit, the present disclosure.

FIG. 1A illustrates a measuring tube with laterally extending connections.

FIG. 1B illustrates an unwanted oscillation of the measuring tube due to rapid flow rate changes.

FIG. 2A illustrates an embodiment of a measuring tube according to the present disclosure.

FIG. 2B illustrates a lateral view of the exemplary embodiment of the measuring tube.

FIG. 2C illustrates a top view of the exemplary embodiment of the measuring tube.

FIG. 3 illustrates an excitation oscillation of the exemplary embodiment of the measuring tube.

FIG. 4 illustrates an oscillation of the exemplary embodiment of the measuring tube due to the Coriolis force.

FIG. 5 illustrates a lateral oscillation of the exemplary embodiment of the measuring tube due to rapid flow rate changes.

FIG. 6 illustrates an alternative embodiment of a measuring tube according to the present disclosure.

It is noted that not all the drawings carry all the reference signs. Instead, in some of the drawings, some of the reference signs have been omitted for the sake of brevity and simplicity of the illustration. Embodiments according to the present disclosure will now be described with reference to the accompanying drawings.

### DETAILED DESCRIPTION

As outlined above, a symmetrical shape wherein inlet and outlet are located on the inside and the measuring tube is routed once around the outside may generally be desirable. That is, a desirable tube shape may comprise a looped tube section that defines a first plane wherein inlet and outlet are connected to the looped tube section from within the looped tube section. Furthermore, it has been found that it may be advantageous to prolong the connections of inlet and outlet. However, since these connections lie within the looped tube section prolonging them may generally require a three-dimensional tube shape wherein the connections are at least partially outside of the first plane defined by the looped tube section.

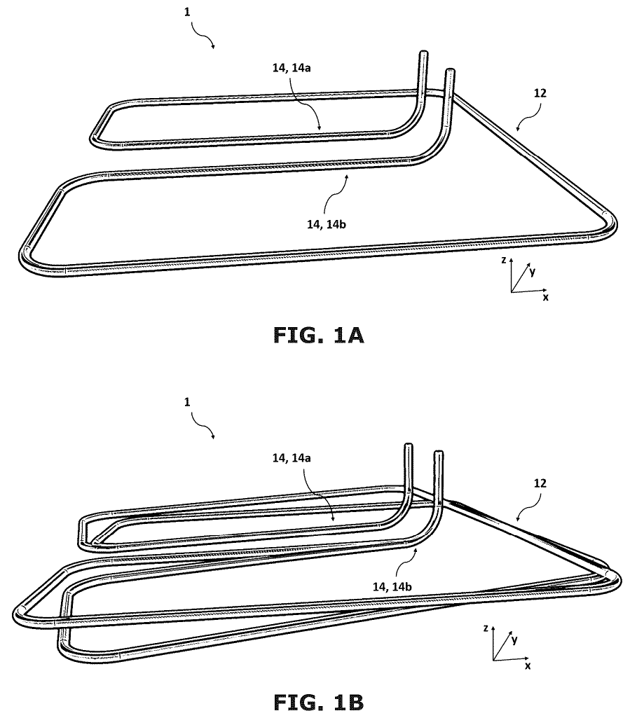

An obvious possibility for prolonging the connections may be to lead them laterally out of the first plane. Such a measuring tube is depicted in FIG. 1A. The measuring tube 1 comprises a looped tube section 12 and two connecting tube sections 14, 14a, 14b, wherein at least a portion of the connecting tube sections 14, 14a, 14b extends laterally out of the first plane defined by the looped tube section 12. However, leading the connecting tube sections laterally out of the first plane breaks the symmetry of the measuring tube, which may lead to undesired problems if not carefully accounted for. Thus, such a measuring tube design may be suitable for measuring a constant or only slowly changing flow rate. This may particularly relate to flow rates whose temporal course does not comprise frequencies in the vicinity of the resonance frequency of undesired oscillations (e.g. the second lowest natural frequency at about 150 Hz). However, by extending laterally out of the first plane the measuring tube is no longer fully symmetric. Therefore, with rapid flow rate changes unwanted oscillations occur due to the recoil when the medium is accelerated. Such rapid flow rate changes may comprise significant changes of the flow rate in less than 10 ms, which may lead to frequency components in the temporal course of the flow rate that are undesirably close to the resonance frequency of the undesired oscillations. These rapid flow rate changes may for example particularly occur when opening or closing a check valve of a pump. These unwanted oscillations are illustrated in FIG. 1B, which shows two different configurations assumed by the measuring tube during these unwanted oscillations. Such oscillation may not be completely distinguishable from the Coriolis effect on the basis of a respective detector signal. Thus, these oscillations would be superimposed on the measuring-tube displacement owing to the Coriolis effect and thereby obstruct precise measurements of the flow rate.

Embodiments according to the present disclosure advantageously suppress such undesirable oscillations, or at least their contribution to a measured signal.

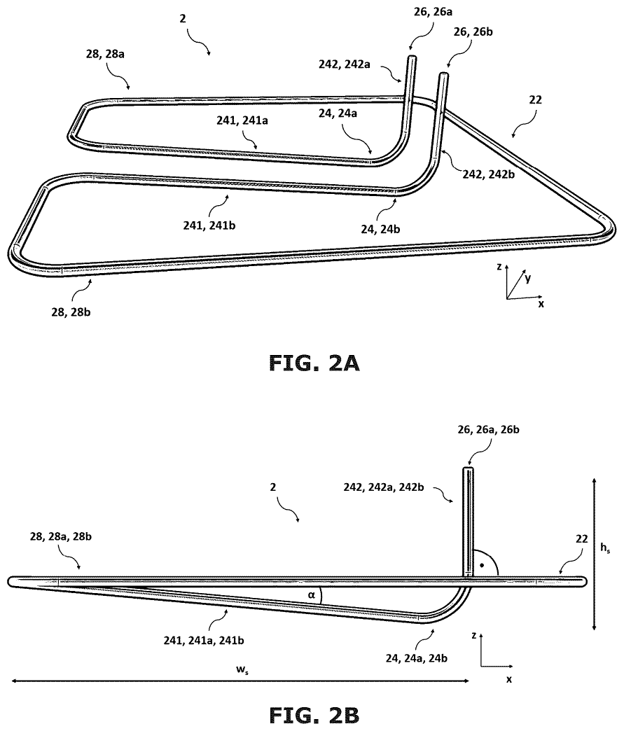

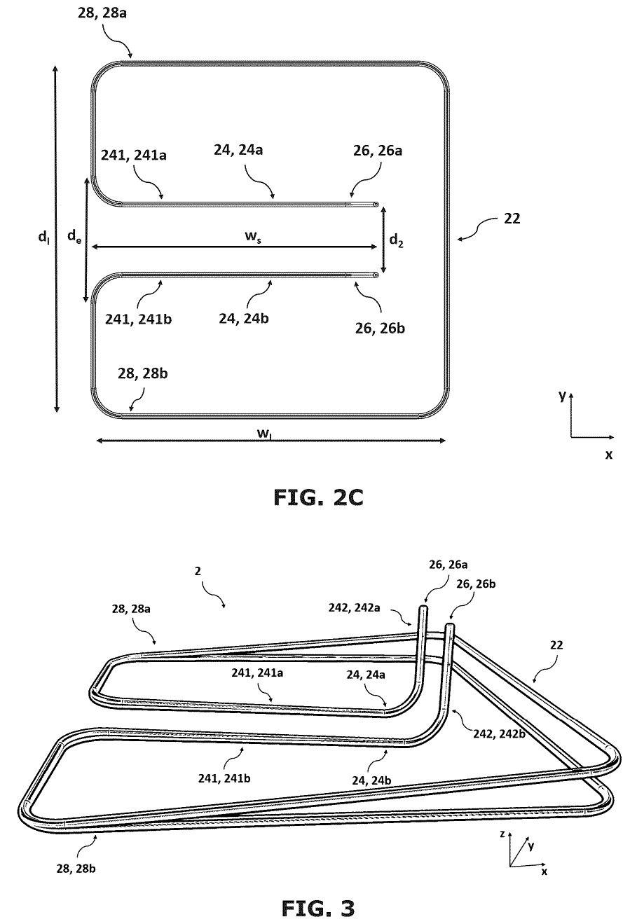

With reference to FIG. 2A, embodiments of the present disclosure are directed at a measuring tube 2 for a Coriolis flow meter comprising a looped tube section 22 and two identically shaped connecting tube sections 24, 24a, 24b, each one fluidly connected to a respective end of the looped tube section 22. The looped tube section 22 is shaped to provide a loop defining a first plane and the connecting tube sections 24, 24a, 24b may be located within the looped tube section when viewed from a direction perpendicular to the first plane. That is, the looped section 22 may be located within the x-y-plane and when projected onto the x-y-plane, the connecting tube sections 24, 24a, 24b may be located within the looped tube section 22 (cf. FIG. 2C). Generally, the two connecting tube sections 24, 24a, 24b may run parallel to each other.

Preferably, the measuring tube 2 may be manufactured from a single integral piece of tubing, e.g., through bending thereof. Preferably, the tube is made of metal. The metal may for example be stainless steel or a nickel-cobalt base alloy like MP35N. Preferably the measuring tube is flexible to allow for respective oscillations thereof with an amplitude of up to 1-2 mm.

It will be understood that the looped tube section 22 may generally resemble any kind of shape wherein the looped tube section lies within a plane and the two ends of the looped tube section are in close vicinity to each other, e.g., less than an end distance de of 10 mm apart. For example, the looped tube section may resemble a quadratic or more generally rectangular shape with rounded corners, a circular or elliptic shape, or combinations thereof. It will be understood that the two ends of the looped tube section may for example be considered to be the ends of the respective straight portions prior to any bending of the tube to the interior of the looped tube section. For example, the looped tube section may be fluidly connected to the connecting tube section via respective bends of the tube as depicted in the Figures, alternatively, these bends may be comprised by the connecting tube section.

It will be understood that relative orientations and positions of tube sections and portions are defined for a resting position of the tube, that is, a position wherein the measuring tube is not in any motion, e.g., owing to an excitation.

The connecting tube sections 24, 24a, 24b may each comprise a first portion 241, 241a, 241b and a second portion 242, 242a, 242b. The first portion 241 of each connecting tube section 24 extends out of the first plane in a first direction (negative z-direction), while the second portion 242 of each connecting tube section 24 extends out of the first plane in a direction opposite to the first direction (z-direction). Preferably, the second portion 242 of each connecting tube section 24 may be oriented perpendicular to the first plane (cf. FIG. 2B).

That is, the first portion 241 may be considered to extend below the first plane while the second portion may be considered to extend above the first plane. It will be understood that the terms “above” and “below” denote two opposite directions with respect to the first plane, wherein one is generally in a first direction perpendicular to the plane and the other one is an opposite direction to the first direction. That is, “above” and “below” generally relate to vertical directions with respect to the plane.

For each connecting tube section 24, the second portion 242 may be further distanced from the looped tube section 22 than the first portion 241. That is, the connecting tube section 24 may comprise a first end, wherein the first end of each of the two connecting tube sections 24 is respectively fluidly connected to a different end of the looped tube section 22. The first portion 241 may then be closer to the first end of the connecting tube section 24 than the second portion 242.

With reference to FIG. 2B, illustrating a lateral view of the exemplary measuring tube embodiment depicted in FIG. 2A, the first portions 241, 241a, 241b of the two connecting tube sections 24, 24a, 24b may define a second plane which is at a non-zero angle α with respect to the first plane. As illustrated, the second portions 242, 242a, 242b may be oriented perpendicular to the first plane and thus along the z-direction. The connecting tube sections 24, 24a, 24b may comprise a section width wₛ denoting the extension in the x-direction and a section height hₛ denoting the extension in the z-direction. Furthermore, the connecting tube sections 24, 24a, 24b may also comprise a section length Is denoting a flow path length of the connecting tube section.

With reference to FIG. 2C, illustrating a top view of the exemplary measuring tube embodiment depicted in FIG. 2A, the connecting tube sections 24 lie within the looped tube section when viewed from above (i.e., along the z-direction). In other words, FIG. 2C illustrates a projection of the measuring tube onto the x-y plane. The looped tube section 22 may comprise a loop width w₁ denoting the extension of the looped tube section 22 in the x-direction and similarly a loop depth d₁ denoting the extension of the looped tube section 22 in the y-direction. Furthermore, the looped tube section 22 may also comprise a loop length Is denoting a flow path length of the looped tube section 22.

The second portion 242 of each connecting tube section 24 may be configured to be fixedly mounted to a holder and/or excitation device, preferably such that there is a rigid connection between the first portions of the two connecting tube sections. In particular, the connecting tube section may comprise a second end 26, 26a, 26b which may be fixedly mounted to the holder and/or excitation device. Preferably, the measuring tube may be excited via the fixedly mounted connecting tube section 24, e.g., through a movement of the holder and/or excitation device. The second ends 26, 26a, 26b of the connecting tube sections 24 may be distanced by a second end distance d₂ in the range of 1-15, e.g. 2-10 mm. When in use, the second ends 26, 26a, 26b may constitute inlet and outlet of the measuring tube, respectively. Thus, a fluid may flow to the second end 26a of the second portion 242a of the connecting tube section 24a and further to the first portion 241a of the connecting tube section 24a from where it will flow into the looped tube section 22, past one of the detection positions 28a, past a centre of the measuring tube in flow direction, past the second of the detection positions 28b and into the first portion 241b of the other connecting tube section 24b, to the second portion 242b of said connecting tube section 24b and out of the respective second end 26b.

An exemplary excitement of the measuring tube 2 is depicted in FIG. 3. For example, the holder and/or excitation device fixedly connected to the second end 26, 26a, 26b of each of the two connecting tube sections 24 may be periodically moved with an amplitude of approx. 1-2 μm and at the lowest eigenfrequency (also referred to as natural frequency) of the measuring tube 2, e.g., by means of a piezoelectric actuator. Said movement may preferably be parallel to the second portion 242 of the connecting tube sections 24, e.g., perpendicular to the first plane defined by the looped tube section. Due to the resonance magnification, the measurement tube 2 thereby oscillates at the eigenmode and with an amplitude of about 0.5-1 mm. The eigenmode of the exemplary measuring tube 2 is illustrated in FIG. 3, wherein two configurations assumed by the measuring tube 2 when oscillating at the eigenfrequency are depicted. In particular, the two configurations depicted in FIG. 3 may correspond to a respective maximum displacement at the two extrema of the eigenmode. It will be understood that the eigenfrequency and the resonance magnification and thus the resulting amplitude may generally depend on the shape, material, and size of the measuring tube. For example, the looped tube section may comprise a section width w₁ and section depth di of 25 mm each and an outer diameter of 0.35 mm.

The first portions 241, 241a, 241b may be configured to compensate for an asymmetry of the measuring tube that is introduced by part of the connecting tube section 24 laterally extending out of the first plane. Thus, the first portion 241 may generally also be referred to as compensating portion. That is, the arrangement and/or dimension of the first portion 241 of each connecting tube section 24 may be designed such that a lateral oscillation mode of the measuring tube 2, which may be excited due to rapid flow changes, does not comprise a component perpendicular to the first plane in the vicinity of the detectors. The design may for example be optimized through experiments and/or calculations based on the finite element method (FEM).

Very generally, the shape of the first portion 241 of each connecting tube section 24 may be designed such that the tube does not move in the first direction (z-direction) at the two detector positions 28, 28a, 28b when the respective eigenmode of the tube is excited. This may substantially be achieved by designing the connecting tube sections 24 such that their respective centre of mass lies within the first plane. However, this may only be an approximation which may serve as a good starting point for further optimization, e.g. using experiments and/or simulations. Generally, it may be sufficient to optimize one design parameter, such as the angle α.

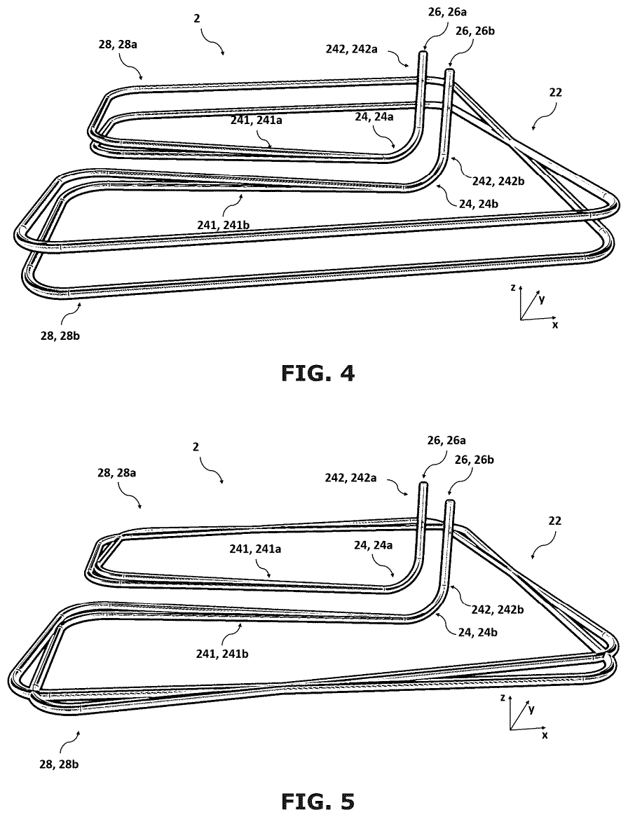

With reference to FIG. 4, an exemplary oscillation owing to the Coriolis force is shown. That is, when a fluid flows through the measuring tube, the Coriolis force may generally induce an additional oscillation that is 90° phase-shifted with respect to the excitation oscillation. The movement owing to the oscillation induced by the Coriolis force can be detected at detection positions 28, 28a, 28b together with a small portion of the excitation oscillation (cf. FIG. 3) by means of a respective position detector, e.g., an optical position detector (for example as described in DE 10 2021 121 402 A1). The amplitude ratio of both oscillations can be adjusted to the desired level by selecting the detector position.

In general, the excitation oscillation and the oscillation owing to the Coriolis force may both be extracted from a detector signal as the excitation oscillation is symmetric with respect to the two detector positions 28, 28a, 28b (cf. FIG. 3) and the oscillation owing to the Coriolis force is asymmetric with respect to two detector positions 28, 28a, 28b (cf. FIG. 4). This may allow to determine both, the mass flow rate owing to the phase shift between the oscillations measured at the two locations 28a, 28b and the density of the fluid based on the detected eigenfrequency, which depends on the mass of the measuring tube and the comprised fluid. In particular, the eigenfrequency can be recognised by the fact that the symmetrical oscillation at the detector positions 28, 28a, 28b is 90° out of phase with the movement generated at the ends 26, 26a, 26b owing to the excitation oscillation. The frequency of the excitation oscillation may thus be readjusted so that it exactly fits to the eigenfrequency, even if it changes over time (e.g., due to a change in solvent composition, pressure and/or temperature). Thereby, the correct eigenfrequency may be determined, which may in turn allow to estimate the density of the fluid.

Preferably, the two detector positions 28, 28a, 28b are arranged symmetrically around a centre of the measuring tube in flow direction.

With reference to FIG. 5, an additional oscillation of the measuring tube can be excited when there is a rapid change in flow rate. However, in contrast to the measuring tube 1 discussed with reference to FIG. 1, the respective oscillation does not comprise a significant vertical component at the detection positions 28, 28a, 28b, preferably no vertical component perpendicular to the first plane.

Since the position detectors may typically be designed to only detect movements in the vertical direction (i.e., perpendicular to the first plane) and are insensitive to lateral movements, this oscillation may advantageously not have any disturbing influence on the measurement signal. In the state of the art, this is usually only achieved by a completely symmetrical shape of the tube, which has other disadvantages, as explained above. Particularly, the lack of elongated connecting tube sections.

Thus, the present disclosure advantageously allows to provide an optimized shape for the measuring tube in which there are points where the movement due to the excitation vibration is small, e.g., as small as possible, and the deflection due to the Coriolis force is comparably large, e.g., is as large as possible. Furthermore, any oscillation that may be excited by a recoil occurring when the flow rate rapidly changes, may not significantly disturb the measurement signal. In particular, even if rapid flow rate changes lead to some residual contribution to the measurement signal, it may allow to filter out oscillations due to rapid changes of the flow rate, for example by means of a low pass filter. That is, while rapid flow rate changes may still excite some oscillations of the tube, these undesired oscillations may generally be many times smaller than for a tube as for example depicted in FIG. 1A. In particular, the amplitude of such undesired oscillations may for example be only on the order of the oscillations due to the Coriolis force and not many times stronger as for tubes known in the state of the art (e.g., depicted in FIG. 1A). The strongly reduced amplitude of undesired oscillations may advantageously facilitate with filtering out the undesired oscillations. Furthermore, a time average of the signal may disadvantageously change due to non-linearities of the undesired oscillations are too strong. Embodiments according to the present disclosure may thus advantageously also allow for a more precise and reliable time average of the signal.

In other words, according to the present disclosure, the measuring tube is guided once in a loop, e.g., a circle. Inside the measuring tube, that is, within the loop, the connecting tube sections (e.g., supply lines) may be led vertically out of the first plane spanned by the looped tube. To compensate for the asymmetry, the measuring tube is guided at a precisely defined distance on the other side of the first plane.

This advantageously allows to provide two detector positions 28, 28a, 28b wherein movement owing to the excitation is only weak while the displacement due to the Coriolis force is strong. Furthermore, the displacement of the measuring tube owing to undesired oscillations excited due to rapid flow changes may advantageously be lateral and thus perpendicular to the displacement owing to the Coriolis force.

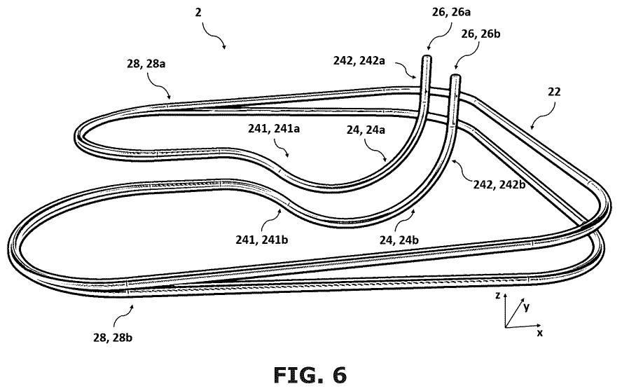

It will be understood that the shape of the measuring tube and particularly also the connecting tube sections may vary and that the shape depicted in FIGS. 2-5 are merely exemplary. Another exemplary shape is depicted in FIG. 6, where it will be understood that like parts are denotes by like reference numerals. The embodiment depicted in FIG. 6 mostly corresponds to the embodiment discussed above with reference to FIGS. 2-5 with the main difference being that the curvatures of the different tube sections and portions are different.

Whenever a relative term, such as “about”, “substantially” or “approximately” is used in this specification, such a term should also be construed to also include the exact term. That is, e.g., “substantially straight” should be construed to also include “(exactly) straight”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

While in the above, a preferred embodiment has been described with reference to the accompanying drawings, the skilled person will understand that this embodiment was provided for illustrative purpose only and should by no means be construed as limiting.

We claim:

1. A measuring tube for a Coriolis flow meter, comprising:
a looped tube section, and
two connecting tube sections,
wherein a first end of each of the two connecting tube sections is respectively fluidly connected to a different end of the looped tube section,
wherein each of the connecting tube sections comprises a first portion and a second portion,
wherein the looped tube section defines a first plane,
wherein the second portion of each connecting tube section extends out of the first plane in a first direction, and
wherein the first portion of each connecting tube section extends out of the first plane in a direction opposite to the first direction.

2. The measuring tube according to claim 1, wherein the measuring tube comprises two detection positions arranged symmetrically around a centre of the measuring tube in a flow direction.

3. The measuring tube according to claim 2, wherein the arrangement and/or dimension of the first portion of each connecting tube section is designed such that a lateral oscillation mode of the measuring tube that can be excited due to rapid flow changes does substantially not comprise a component perpendicular to the first plane in a vicinity of the detection positions.

4. The measuring tube according to claim 1, wherein the two connecting tube sections are mirror-symmetrical to each other.

5. The measuring tube according to claim 1, wherein the first portions of the two connecting tube sections are configured to compensate for an asymmetry of the measuring tube introduced by the second portion.

6. The measuring tube according to claim 1, wherein the second portion of each connecting tube section is oriented perpendicular to the first plane.

7. The measuring tube according to claim 1, wherein the measuring tube comprises an outer tube diameter in the range of 0.2 to 1 mm.

8. The measuring tube according to claim 1, wherein the measuring tube is configured for internal pressures of at least up to 500 bar.

9. The measuring tube according to claim 1, wherein the measuring tube is at least configured for mass flow rates in the range of 0-10 g/min.

10. The measuring tube according to claim 1, wherein the first portions of the two connecting tube sections extend out of the first plane in the direction opposite to the first direction by an extent such that a centre of mass of the connecting tube section is located close to the first plane.

11. The measuring tube according to claim 1, wherein the first portions of the two connecting tube sections define a second plane which is at a non-zero angle with respect to the first plane.

12. The measuring tube according to claim 11, wherein the angle is within the range of 1° to 30°.

13. The measuring tube according to claim 1, wherein the measuring tube comprises an eigenfrequency in the range of 50-500 Hz.

14. A Coriolis flow meter comprising:
the measuring tube according to claim 1;
an excitation device configured to excite an oscillation of the measuring tube; and
two position detectors configured to detect a position of the measuring tube with respect to one dimension.

15. The Coriolis flow meter according to claim 14, wherein the Coriolis flow meter is configured such that, when a fluid flows through the measuring tube, a Coriolis force induces an oscillation of the measuring tube that is 90° phase-shifted with respect to an excitation oscillation induced via the excitation device.

16. The Coriolis flow meter according to claim 14, wherein the excitation device comprises a piezoelectric actuator.

17. The Coriolis flow meter according to claim 14, wherein the excitation device is configured to periodically move each of the two connecting tube sections at a lowest eigenfrequency of the measuring tube.

18. The Coriolis flow meter according to claim 14, wherein the excitation device comprises a holder, and wherein the measuring tube is fixedly mounted to the holder.

19. The Coriolis flow meter according to claim 18, wherein each connecting tube section comprises a second end, and wherein each second end is fixedly mounted to the holder such that there is a rigid connection between the two second ends.

20. The Coriolis flow meter according to claim 14, wherein the measuring tube comprises two detection positions arranged symmetrically around a centre of the measuring tube in a flow direction, wherein each position detector is located at one of the two detection positions, and wherein the Coriolis flow meter is configured such that a movement owing to an undesired excitation originating from a rapid flow change results in a lateral oscillation mode that is perpendicular to a direction in which the two position detectors are configured to detect the position of the measuring tube.

21. The Coriolis flow meter according to claim 14, wherein the two position detectors are configured to only detect the position of the measuring tube in a direction perpendicular to the first plane defined by the looped tube section of the measuring tube.

22. The Coriolis flow meter according to claim 14, wherein the Coriolis flow meter is configured to measure mass flow rates at least in the range of 0 to 2 g/min, wherein the Coriolis flow meter is configured to measure mass flow rates at fluid pressures at least in the range of 5 to 50 MPa, and wherein the Coriolis flow meter is configured to measure mass flow rates with an accuracy of 100 μg/min.
